(19) United States
(12) Patent Application Publication
(10) Pub. No.: US 2024/0038414 A1
(43) Pub. Date: Feb. 1, 2024

(54) FLAT RIBBON TYPE CONDUCTIVE WIRE BODY AND FLAT RIBBON TYPE WIRE HARNESS

(71) Applicant: Changchun Jetty Automotive Technology Co., Ltd., Changchun, Jilin (CN)

(72) Inventor: Chao WANG, Changchun, Jilin (CN)

(73) Assignee: Changchun Jetty Automotive Technology Co., Ltd., Changchun, Jilin (CN)

(21) Appl. No.: 18/257,039

(22) PCT Filed: Oct. 15, 2021
(86) PCT No.: PCT/CN2021/124045

§ 371 Date: Jun. 12, 2023

(30) Foreign Application Priority Data
Dec. 18, 2020 (CN) 202011513821.7

(51) Int. Cl. H01B 7/08; H01B 1/02; H01B 7/02

(52) U.S. Cl. CPC H01B 7/0861; H01B 1/023; H01B 7/0208; H01B 1/026; H01B 1/04

(57) ABSTRACT

The present disclosure provides a flat ribbon type conductive wire body and a flat ribbon type wire harness. The flat ribbon type conductive wire body includes a conductive core body, an insulating layer, and a shielding layer. The insulating layer wraps the conductive core body, and the shielding layer is disposed outside the insulating layer. The flat ribbon type conductive wire body has a good electromagnetic shielding function, a strong anti-electromagnetic interference capability and low requirements for installation space, can be widely used in occasions having high requirements for signal transmission stability, and improves the space requirement of the whole vehicle for wire harness layout.

### TECHNICAL FIELD

The present disclosure relates to the technical field of electrical connections, and particularly to a flat ribbon type conductive wire body and a flat ribbon type wire harness.

### BACKGROUND

A power supply and an electrical device on a vehicle are electrically connected by a wire harness. The round wire is a technical solution commonly used by those skilled in the art at present. With the gradual development of new energy vehicles, the functions of electrical appliances in the vehicle are gradually increasing, and the available wiring space in the vehicle is getting smaller. Meanwhile, as the power of the electrical appliances used in the new energy vehicles is much higher than that of the traditional fuel vehicles, the problems of increased current carrying capacity, increased wire diameter and increased electromagnetic interference of the wire harness caused by the increased power are increasingly prominent. Therefore, it has become an urgent technical problem for those skilled in the art to find a technical solution that can adapt to the small wiring space in the vehicle and solve the problem of electromagnetic interference generated by the wire harness itself.

### SUMMARY

The present disclosure aims to provide a flat ribbon type conductive wire body and a flat ribbon type wire harness, which can adapt to the small wiring space in the vehicle and solve the electromagnetic interference generated by the wire harness itself. The flat ribbon type wire harness may be attached to a vehicle body and formed in accordance with the shape of the vehicle body. According to the principle of skin effect, the cross-sectional area of the flat ribbon type conductive wire body is smaller than that of the round wire with the same current carrying capacity as the flat ribbon type conductive wire body, so that the flat ribbon type conductive wire body require less wiring space in the vehicle. Meanwhile, in the present disclosure, a shielding layer is inventively disposed outside an insulating layer of the flat ribbon type conductive wire body, which can effectively solve the electromagnetic interference to peripheral electrical appliances generated by the flat ribbon type conductive wire body when energized. Therefore, the technical solutions of the present disclosure can solve the problems of insufficient wiring space and electromagnetic interference in automobiles, especially new energy automobiles, to a certain extent.

The present disclosure provides a flat ribbon type conductive wire body, including a conductive core body, an insulating layer and a shielding layer. The insulating layer wraps the conductive core body, and the shielding layer is disposed outside the insulating layer.

By providing the shielding layer, it is possible to make the flat ribbon type conductive wire body have a good electromagnetic shielding function, a strong anti-electromagnetic interference capability and a low requirement for mounting space, and can be widely used in occasions having a high requirement for signal transmission stability; meanwhile, it is possible to avoid the problems of large occupied space and high cost resulting from the use of large-area shielding wires, and satisfy the space requirement of the whole vehicle for the wire harness layout.

Further, the flat ribbon type conductive wire body further includes a protective layer which wraps the shielding layer. Further, the shielding layer includes a shielding tape which is wound to wrap an outer side of the insulating layer.

The shielding layer adopts the shielding tape which is wound to wrap the outer side of the insulating layer, so that the shielding layer can be easily processed.

As an optional solution, the shielding tape is spirally wound with a set overlapping width on the insulating layer.

The shielding tape is spirally wound with a set overlapping width on the insulating layer, i.e., the shielding tape is densely wound on the insulating layer. Specifically, during winding, a part of each turn of the shielding tape covers a previous turn of the shielding tape, with an overlapping portion therebetween, and a width of the overlapping portion is the overlapping width. This winding mode is simple and easy for operation, facilities the processing, and wraps the insulating layer and the conductive core body more completely without any exposed part, thereby achieving a better shielding effect. As an optional solution, a plurality of shielding tapes may be alternately wound on the insulating layer, and specifically, a width of a position where the shielding tapes are overlapped and intersected is the overlapping width.

Further, the set overlapping width is 1% to 95% of a width of the shielding tape.

Exemplarily, the set overlapping width is 5% to 50% of the width of the shielding tape.

The width of the overlapping portion may be 1% to 95% of the width of the shielding tape. Exemplarily, the set overlapping width is 5% to 50% of the width of the shielding tape, so that the shielding layer can wrap the insulating layer and the conductive core body more completely, and most of the conductive core bodies are wrapped by the shielding tape, thereby further improving the electromagnetic shielding performance.

Further, a material of the shielding tape includes an aluminum foil and/or a copper foil.

The aluminum foil and the copper foil have light weights, high ductility, good electromagnetic shielding capabilities, low material costs and low processing costs. As an optional solution, the shielding layer is made of one or more selected from the group consisting of a shielding metal and a composite material thereof, a shielding plastic, a shielding rubber, and shielding fabrics.

Further, a thickness of the shielding layer is 0.001 mm to 27 mm

The shielding layer with a thickness of 0.001 mm to 27 mm can ensure the shielding effect, and can also avoid the mounting of the flat ribbon type conductive wire body from being affected by an excessive bending radius thereof. Further, the shielding layer covers at least 7.8% of a surface area of the insulating layer, i.e., the shielding layer covers more than 7.8% of the surface area of the insulating layer. Further, a thickness of an interval between the insulating layer and the shielding layer is not greater than 157 mm, i e , the thickness of the interval between the insulating layer and the shielding layer is less than or equal to 157 mm.

Further, the insulating layer wraps the conductive core body by means of one or more selected from the group consisting of an extrusion process, an injection molding process, a spraying process, a dipping molding process, a slush molding process, an electrophoresis process, a winding process, and a weaving process.

Further, the protective layer wraps the shielding layer by means of one or more selected from the group consisting of an extrusion process, an injection molding process, a spraying process, a dipping molding process, a slush molding process, an electrophoresis process, a weaving process, and a winding process.

Further, a material of the conductive core body is one or more selected from the group consisting of aluminum, aluminum alloy, copper, copper alloy, silver, and silver alloy.

Optionally, the conductive core body is an aluminum flat ribbon, which has the advantages of light weight, stable electrical connection performance and low cost.

Further, the material of the conductive core body contains carbon or carbon-based compounds, such as graphite, carbon nanotubes, graphene, etc., which also have excellent conductivity.

Further, a material of the insulating layer is one or more selected from the group consisting of polyvinyl chloride, polyurethane, nylon, polypropylene, silicone rubber, crosslinked polyolefin, synthetic rubber, polyurethane elastomer, crosslinked polyethylene, and polyethylene.

As an optional solution, the number of the conductive core body is one.

As an optional solution, the number of the conductive core bodies is at least two, at least one of the conductive core bodies is externally wrapped by the insulating layer, and at least one insulating layer is wrapped by at least one shielding layer.

Specifically, the flat ribbon type conductive wire body is a multi-core body flat ribbon type conductive wire body, which includes a protective layer, an insulating layer, and at least two conductive core bodies. Each of the protective layer, the insulating layer and the conductive core body is of flat shape. At least one of the conductive core bodies is externally wrapped by the insulating layer, and the protective layer is the outermost layer of the flat ribbon type conductive wire body.

The flat ribbon type conductive wire body includes at least two conductive core bodies. That is, one flat ribbon type conductive wire body is integrated with a plurality of conductive core bodies, so as to achieve independent electrical connection of a plurality of paths, and a plurality of paths can be arranged by fixing one flat ribbon type conductive wire body according to the present disclosure. On the one hand, it is possible to avoid the problem of poor connection stability when a plurality of flat ribbon type wire harnesses independent from each other are connected to form a plurality of paths, thereby avoiding the risk of falling off after loading. On another hand, a plurality of conductive core bodies are integrated into one conductive wire body, so that the structure is regular and compact and occupies less mounting space. On still another hand, the process of assembling a plurality of flat ribbon type wire harnesses is saved, so as to improve the mounting efficiency, and facilitate the intelligent manufacturing. In addition, the flat ribbon type conductive wire body not only allows independent electrical connection of a plurality of paths, but also achieves a good electromagnetic shielding performance

As an optional solution, the at least two conductive core bodies are arranged in sequence along a width direction of the conductive core body.

As an optional solution, the at least two conductive core bodies are stacked along a thickness direction of the conductive core body.

As an optional solution, the plurality of conductive core bodies are disposed in both the width direction and the thickness direction of the conductive core body.

Further, the at least two conductive core bodies are disposed to be directly opposite to each other in a same stacking direction.

The flat ribbon type conductive wire body is of regular structure and convenient to be processed and manufactured.

The flat ribbon type conductive wire body not only allows independent electrical connection of a plurality of paths, but also achieves a good electromagnetic shielding performance

Further, the plurality of insulating layers are integrally formed, so that the flat ribbon type conductive wire body is more stable, and it is convenient to arrange the protective layer.

The present disclosure provides a flat ribbon type wire harness, which includes a terminal and the aforementioned flat ribbon type conductive wire body. The terminal is connected to an end of the conductive core body.

It should be understood that both the foregoing general description and the following specific embodiments are for the purpose of illustration and description and are not intended to limit the protection scope of the present disclosure.

### BRIEF DESCRIPTION OF THE DRAWINGS

For a clearer illustration of the specific embodiments of the present disclosure, a brief description of the drawings for the specific embodiments or the prior art will be given below. Obviously, the drawings described below involve only some embodiments of this disclosure. For those of ordinary skill in the art, other drawings can be derived from these drawings without any inventive efforts.

FIG. 1 illustrates a structural diagram of a first flat ribbon type conductive wire body according to the present disclosure;

FIG. 2 illustrates a structural diagram of a second flat ribbon type conductive wire body according to the present disclosure;

FIG. 3 illustrates a structural diagram of a third t flat ribbon type conductive wire body according to the present disclosure;

FIG. 4 illustrates a structural diagram of a fourth flat ribbon type conductive wire body according to the present disclosure;

FIG. 5 illustrates a structural diagram of a fifth flat ribbon type conductive wire body according to the present disclosure;

FIG. 6 illustrates a structural diagram of a sixth flat ribbon type conductive wire body according to the present disclosure;

FIG. 7 illustrates a structural diagram of a seventh flat ribbon type conductive wire body according to the present disclosure;

FIG. 8 illustrates a structural diagram of an eighth flat ribbon type conductive wire body according to the present disclosure;

FIG. 9 illustrates a structural diagram of a ninth flat ribbon type conductive wire body according to the present disclosure;

FIG. 10 illustrates a structural diagram of a tenth flat ribbon type conductive wire body according to the present disclosure;

FIG. 11 illustrates a structural diagram of an eleventh flat ribbon type conductive wire body according to the present disclosure;

FIG. 12 illustrates a sectional view of a shielding layer according to an embodiment of the present disclosure;

FIG. 13 illustrates a sectional view of a shielding layer according to another embodiment of the present disclosure.

### REFERENCE NUMERALS OF MAIN COMPONENTS

10: protective layer; 20: insulating layer; 30: conductive core body; 40: shielding layer; 41: shielding tape; 42: overlapping portion; 411: aluminum foil tape; 412: copper foil tape.

### DETAILED DESCRIPTION

The technical solutions of the present disclosure will be clearly and completely described below with reference to the drawings. Obviously, the described embodiments are only a part, rather than all, of the embodiments of the present disclosure.

The components of the embodiments of the present disclosure generally described

and illustrated in the drawings may be arranged and designed in various different configurations. Therefore, the following detailed description of the embodiments of the present disclosure merely represents the selected embodiments of the present disclosure, and do not intended to limit the scope of the present disclosure.

All other embodiments derived by persons skilled in the art from the embodiments of the present disclosure without making inventive efforts shall fall within the scope of the present disclosure.

It should be noted that the flat ribbon type conductive wire body according to the embodiments of the present disclosure may be used in, but not limited to, vehicles, and may also be used in other devices and apparatuses requiring electrical connections.

It should be noted that ‘a plurality of conductive core bodies 30’, i.e., ‘at least two conductive core bodies 30’ in the embodiments of the present disclosure means that the number of the conductive core bodies 30 is two or more.

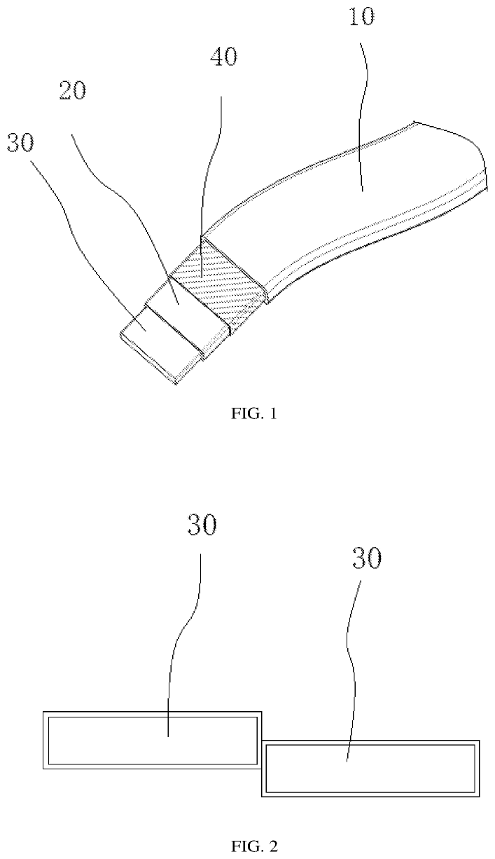

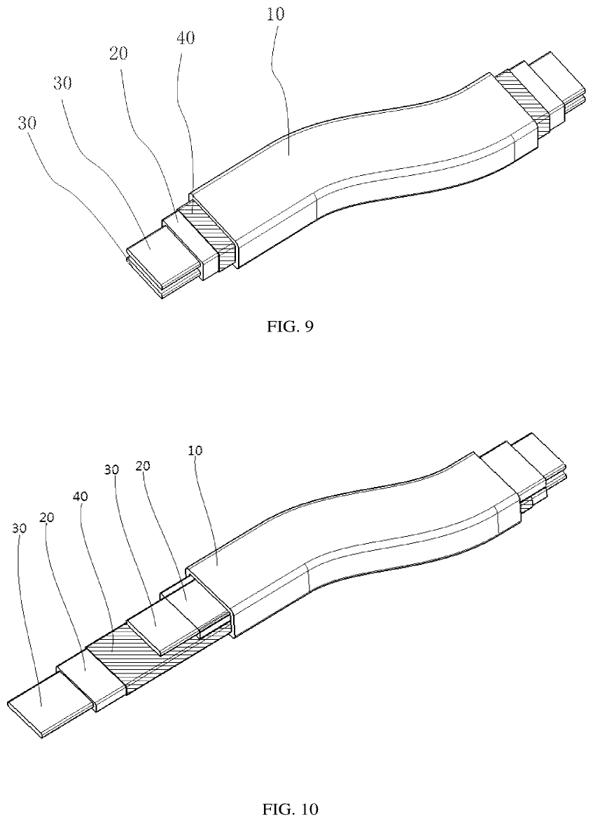

As illustrated in FIGS. 1, 3, 5 and 6 to 11, the present disclosure provides a flat ribbon type conductive wire body, which includes a conductive core body 30, an insulating layer 20, and a shielding layer 40. The insulating layer 20 wraps the conductive core body 30. The shielding layer 40 is disposed outside the insulating layer 20. By providing the shielding layer 40, it is possible to make the flat ribbon type conductive wire body according to the embodiments have a good electromagnetic shielding function, a strong anti-electromagnetic interference capability and a low requirement for mounting space, and can be widely used in occasions having a high requirement for signal transmission stability; meanwhile, it is possible to avoid the problems of large occupied space and high cost resulting from the use of large-area round shielding wires with a shielding function, and satisfy the space requirement of the whole vehicle for wire harness layout.

It should be noted that a length and a width of the insulating layer 20 and a length and a width of the shielding layer 40 may be set in accordance with a length and a width of the conductive core body 30.

The shielding layer 40 is disposed outside the insulating layer 20 to wrap the insulating layer 20 and therefore wrap the conductive core body 30. The shielding layer 40 and the insulating layer 20 may be closely attached to each other. Alternatively, there is a gap between the shielding layer 40 and the insulating layer 20. The relationship between the thickness of the gap between the shielding layer and the insulating layer (i.e., a vertical distance from a point on the insulating layer to the shielding layer) and the released interference of the flat ribbon type conductive wire body is illustrated as follows in Table 1:

TABLE 1

| | Distance between the insulating layer and the shielding layer | | | | | | | | | |
|---|---|---|---|---|---|---|---|---|---|---|
| Parameter | 0 mm | 7 mm | 17 mm | 27 mm | 37 mm | 47 mm | 57 mm | 67 mm | 77 mm | 87 mm |
| Released interference | 5.2 dB | 5.9 dB | 6.3 dB | 6.9 dB | 7.5 dB | 8.3 dB | 9.8 dB | 11.1 dB | 13.2 dB | 14.3 dB |
| | Distance between the insulating layer and the shielding layer | | | | | | | | | |
| Parameter | 97 mm | 107 mm | 117 mm | 127 mm | 137 mm | 147 mm | 157 mm | 167 mm | 177 mm | 187 mm |
| Released interference | 15.2 dB | 15.9 dB | 16.4 dB | 16.9 dB | 17.7dB | 18.8 dB | 19.6 dB | 23.5 dB | 30.6 dB | 35.6 dB |

As can be seen from the test results shown in Table 1, when the distance between the shielding layer 40 and the insulating layer 20 (the thickness of the gap between the shielding layer and the insulating layer) is 157 mm, the released interference of the flat ribbon type conductive wire body is 19.6 dB, which is less than 20 dB; when the distance between the shielding layer 40 and the insulating layer 20 is greater than 157 mm, the released interference of the flat ribbon type conductive wire body is greater than 20 dB. According to the introduction to the shielding effectiveness in relevant standards, the requirements of shielding level can be satisfied when the released interference is less than 20 dB. Therefore, the gap should be no greater than 157 mm, so as to ensure the shielding effect.

Specifically, the flat ribbon type conductive wire body further includes a protective layer 10 which wraps the shielding layer 40. In this embodiment, the protective layer 10 is disposed outside the shielding layer 40, so as to protect the shielding layer and prolong the service life of the flat ribbon type conductive wire body.

Each of the protective layer 10, the insulating layer 20 and the conductive core body may be of flat shape.

A material of the insulating layer 20 may be polycarbonate, polyvinyl chloride (PVC), polyurethane (PUR), nylon (PA), polypropylene (PP), TPU, silicone rubber (SIR), XLPE, TPU, TPV, PE, polysulfone, polytetrafluoroethylene, polyethylene, polyphenylene ether, polyester, PPS, phenolic resin, urea formaldehyde, DAP, TPE, XPE, XLPE, PFE, ETFE, TPR, TPE-O, perfluoroalkoxy alkane, TPE-S, PBT, EZM, styrene-acrylonitrile copolymer, ABS, polymethacrylate, EVA, polyphenylene sulfide, polystyrene, PBT, polyoxymethylene resin, natural rubber, styrene-butadiene rubber, nitrile butadiene rubber, cis-butadiene rubber, isoprene rubber, ethylene-propylene rubber, chloroprene rubber, butyl rubber, fluororubber, polyurethane rubber, polyacrylate rubber, chlorosulfonated polyethylene rubber, epichlorohydrin rubber, chlorinated polyethylene rubber, chlorosulfurized rubber, butadiene rubber, hydrogenated nitrile rubber, polysulfide rubber, etc.

Exemplarily, the material of the insulating layer 20 is one or more selected from the group consisting of polyvinyl chloride (PVC), polyurethane (PUR), nylon (PA), polypropylene (PP), silicone rubber (SIR), crosslinked polyolefin (XLPO), synthetic rubber, polyurethane elastomer, crosslinked polyethylene (XLPE) and polyethylene (PE), for example, a combination of polypropylene and polyethylene, or a combination of polyvinyl chloride and polyethylene, etc.

A material of the conductive core body 30 may be one or more selected from the group consisting of nickel, cadmium, zirconium, chromium, manganese, aluminum, tin, titanium, zinc, cobalt, gold, and silver, or alloys thereof. Alternatively, the material of the conductive core body may be aluminum-magnesium alloy, aluminum-lithium alloy, aluminum-manganese alloy, aluminum-zinc alloy, or aluminum-silicon alloy. Alternatively, the material of the conductive core body contains carbon or carbon-based compounds, such as graphite, graphene, carbon nanotubes and the like. Optionally, the material of the conductive core body may be one or more selected from the group consisting of aluminum, aluminum alloy, copper, copper alloy, silver, and silver alloy.

On the basis of the above embodiments, the shielding layer 40 may be woven by shielding metal (e.g., copper or aluminum) pieces, or mixed-woven by shielding metal and plastic pieces (e.g., plastic pieces such as ABS with a metal layer such as copper or aluminum on their outer side), or the shielding layer 40 is of sheet structure, or the shielding layer 40 is of structure in which a plurality of shielding tapes are crossed and overlapped, or the shielding layer 40 is of layered structure formed by metal and plastic, such as a PET aluminum foil.

The shielding layer may be formed by one or more selected from the group consisting of shielding metal and a composite material thereof, shielding plastic, shielding rubber, and shielding fabrics. The shielding plastic and shielding rubber is formed by adding a metal material such as copper or aluminum, or a material such as graphene into a raw material during the production of plastics or rubber. The structure forming the shielding fabrics has a part made of a shielding metal.

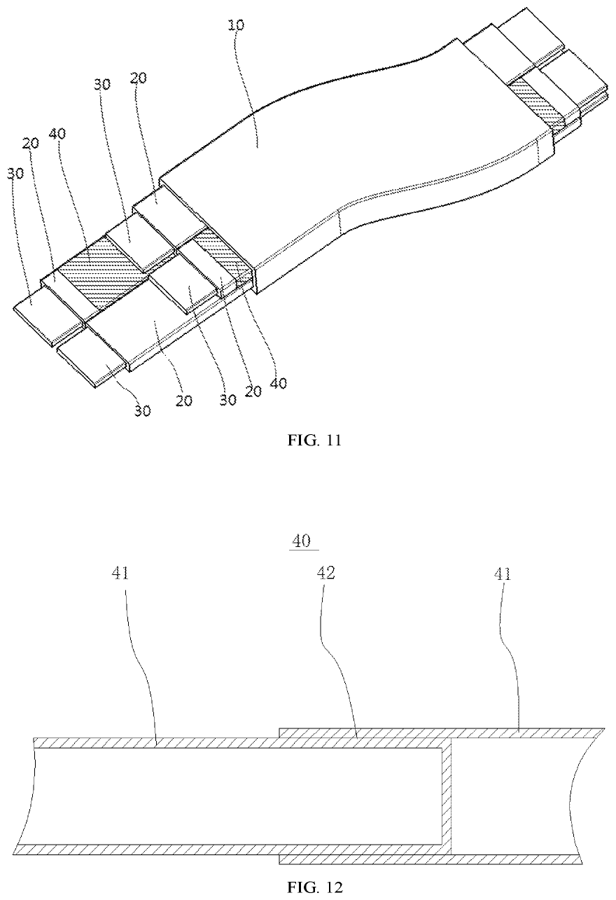

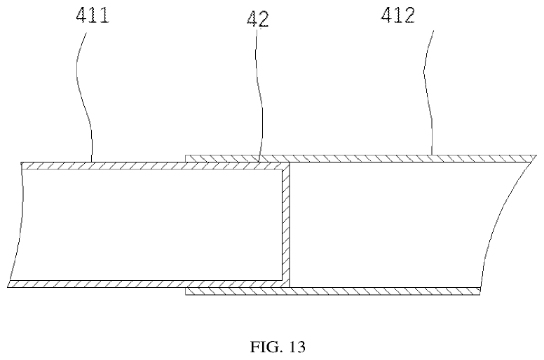

Optionally, as illustrated in FIGS. 12 and 13, in the embodiment, the shielding layer includes a shielding tape 41 which is wound to wrap an outer side of the insulation layer 20, so that the shielding layer 40 can be easily processed.

The shielding tape 41 may be wound in various ways, as long as it can wrap the insulating layer 20. For example, a plurality of turns of shielding tapes 41 independent from each other are disposed along a length direction of the insulating layer 20. It can be understood that the shielding tapes 41 has a plurality of sections. It may be possible to wind one section of the shielding tapes 41 at a position on an outer wall of the insulating layer 20, and then wind another section of the shielding tapes 41 at an adjacent position, and then repeat the above operations until the entire conductive core body 30 wrapped with the insulating layer 20 is wrapped by the shielding tape 41. Optionally, each turn of the shielding tape 41 and the previous turn of the shielding tape 41 have an overlapped portion, so that the shielding layer 40 achieves a better wrapping effect on the insulating layer 20, and the flat ribbon type conductive wire body achieves a better electromagnetic shielding effect.

As an optional solution, as illustrated in FIG. 12, the shielding tape 41 is spirally wound with a set overlapping width on the insulating layer 20, i.e., the shielding tape 41 is densely wound on the insulating layer 20. Specifically, during winding, a part of each turn of the shielding tape 41 covers a previous turn of the shielding tape 41, with an overlapping portion 42 therebetween, and a width of the overlapping portion 42 is the overlapping width. A continuous section of shielding tape 41 may be wound on the insulating layer 20 without an interruption. The winding mode is simple and easy for operation, facilities the processing, and wraps the insulating layer 20 and the conductive core body 30 more completely without any exposed part, thereby achieving a better shielding effect.

The set overlapping width, i.e., the width of the overlapping portion 42, may be 1% to 95% of the width of the shielding tape 41. Table 2 shows the shielding effectiveness of the flat ribbon type conductive wire body when the set overlapping width is 0% to 5% of the width of the shielding tape 41. Table 3 shows the shielding effectiveness of the flat ribbon type conductive wire body when the set overlapping width is 0% to 100% of the width of the shielding tape 41. The details are as follows:

TABLE 2

| | Overlapping percentage | | | | | |
|---|---|---|---|---|---|---|
| Parameter | 0% | 1% | 2% | 3% | 4% | 5% |
| Shielding | 19.7 dB | 25.9 dB | 27.2 dB | 28.4 dB | 29.2 dB | 44.3 dB |
| effectiveness | | | | | | |

TABLE 3

| | Overlapping percentage | | | | | | | | | |
|---|---|---|---|---|---|---|---|---|---|---|
| Parameter | 0% | 5% | 15% | 20% | 25% | 30% | 35% | 40% | 45% | 50% |
| Shielding effectiveness | 19.7 dB | 44.3 dB | 48.7 dB | 53.6 dB | 57.1 dB | 60.9 dB | 62.2 dB | 65.3 dB | 68.2 dB | 7.21 dB |
| | Overlapping percentage | | | | | | | | | |
| Parameter | 55% | 60% | 65% | 70% | 75% | 80% | 85% | 90% | 95% | 100% |
| Shielding effectiveness | 72.2 dB | 72.2 dB | 72.3 dB | 72.6 dB | 72.9 dB | 73.2 dB | 73.5 dB | 73.6 dB | 73.8 dB | 73.8 dB |

As can be seen from the test results shown in Tables 2 and 3, when the set overlapping width is greater than 1% of the width of the shielding tape 41, the shielding effectiveness is greater than 20 dB, which meets the requirements of relevant standards; when the set overlapping width is greater than 95%, the shielding effectiveness is almost unchanged. In order to save the use amount of the shielding tape, the range of the set overlapping width is limited to 1% to 95%. As can be seen from the above data, when the set overlapping width is 5% of the width of the shielding tape 41, the shielding effectiveness is obviously improved; when the percentage of the set overlapping width reaches 50%, the shielding effectiveness may reach 72.1 dB; and when the percentage of the set overlapping width exceeds 50%, the test data does not change obviously. In order to reduce the use amount of the shielding tape, it is recommended that the set overlapping width, i.e., the width of the overlapping portion 42, is exemplarily 5% to 50% of the width of the shielding tape 41.

As illustrated in FIG. 12, the material of the shielding tape 41 may be a material with electromagnetic shielding function such as a PET aluminum foil.

As an optional solution, the material of the shielding tape 41 includes an aluminum foil and/or a copper foil. That is, the shielding tape 41 may be an aluminum foil tape which is wound on the insulating layer 20 to form an aluminum foil shielding layer. The shielding tape 41 may also be a copper foil tape which is wound on the insulating layer 20 to form a copper foil shielding layer. In this case, if the shielding tape 41 is densely wound, a continuous section of aluminum foil tape or copper foil tape may be wound on the insulating layer 20. Alternatively, the shielding tape 41 includes both the aluminum foil tape and the copper foil tape. For example, as illustrated in FIG. 13, the shielding tape 41 is spliced by a section of aluminum foil tape 411 and a section of copper foil tape 412 to form a spliced or overlapped structure, and the aluminum foil tape 411 and the copper foil tape 412 have overlapped parts at the spliced or overlapped position. In this case, if the shielding tape 41 is densely wound, the spliced or overlapped structure may wound on the insulating layer 20. For another example, a plurality of the shielding layers 40 are sequentially disposed from inside to outside, i.e., one shielding layer 40 wraps the previous shielding layer 40, in which at least one shielding layer 40 is an aluminum foil shielding layer formed by winding an aluminum foil tape, and another shielding layer 40 is a copper foil shielding layer formed by winding a copper foil tape; or an aluminum foil shielding layer and a copper foil shielding layer are alternately disposed.

In the embodiment, on the whole, the aluminum foil and the copper foil have light weights, high ductility, good electromagnetic shielding capabilities, low material costs and low processing costs. Comparatively, the aluminum foil is lighter than the copper foil, and the copper foil has a better shielding capability than the aluminum foil. The aluminum foil or the copper foil can be selected as needed. However, the protection scope of the present disclosure is not limited to the copper foil or the aluminum foil, and any other shielding material is also possible.

On the basis of the above embodiments, the thickness of the shielding layer 40 may be set according to the specific conditions. For example, considering the influences of the thickness of the shielding layer on an Electromagnetic Interference (EMI), a Radio Frequency Interference (FRI), and a bending radius of the flat ribbon type conductive wire body comprehensively, it is possible to select an appropriate thickness of the shielding layer. A relationship between the thickness of the shielding layer and the EMI, a relationship between the thickness of the shielding layer and the FRI, and a relationship between the thicknesses of the shielding layer and an increment of the bending radius of the flat ribbon type conductive wire body are shown as follows in Table 4.

TABLE 4

| | Thickness of shielding layer | | | | | | | | | | | | | | | |
|---|---|---|---|---|---|---|---|---|---|---|---|---|---|---|---|---|
| Parameter | 0.001 mm | | 0.05 mm | | 1 mm | | 3 mm | | 5 mm | | 7 mm | | 9 mm | | 11 mm | |
| Anti-EMI | 2.1 | dB | 4.3 | dB | 5.4 | dB | 19.3 | dB | 27.6 | dB | 38.4 | dB | 45.5 | dB | 58.4 | dB |
| Anti-FRI | 1.4 | dB | 2.6 | dB | 3.2 | dB | 14.4 | dB | 25.3 | dB | 35.2 | dB | 48.8 | dB | 67.7 | dB |
| Increment of anti- | 1 | mm | 2 | mm | 4 | mm | 5 | mm | 6 | mm | 8 | mm | 9 | mm | 10 | mm |

bending radius

| | Thickness of shielding layer | | | | | | | | | | | |
|---|---|---|---|---|---|---|---|---|---|---|---|---|
| Parameter | 13 mm | | 15 mm | | 17 mm | | 19 mm | | 21 mm | | 23 mm | |
| Anti-EMI | 68.5 | dB | 85.1 | dB | 96.4 | dB | 104.2 | dB | 113.3 | dB | 116.6 | dB |
| Anti-FRI | 77.3 | dB | 88.1 | dB | 98.4 | dB | 105.4 | dB | 116.2 | dB | 118.3 | dB |
| Increment of anti- | 12 | mm | 15.5 | mm | 24 | mm | 59 | mm | 95 | mm | 135 | mm |

bending radius

| | Thickness of shielding layer | | | | | | | | | | | |
|---|---|---|---|---|---|---|---|---|---|---|---|---|
| Parameter | 25 mm | | 27 mm | | 29 mm | | 31 mm | | 33 mm | | 35 mm | |
| Anti-EMI | 117.9 | dB | 119.6 | dB | 120.6 | dB | 120.6 | dB | 120.8 | dB | 120.9 | dB |
| Anti-FRI | 119.1 | dB | 121.4 | dB | 120.5 | dB | 120.6 | dB | 120.7 | dB | 120.8 | dB |
| Increment of anti- | 178 | mm | 189 | mm | 231 | mm | 246 | mm | 269 | mm | 281 | mm |

bending radius

As can be seen from the test results shown in Table 4, when the thickness of the shielding layer 40 is between 0.001 mm and 27 mm, the shielding effect of the flat ribbon type conductive wire body, i.e., the anti-Electromagnetic Interference (EMI) and the anti-Radio Frequency Interference (FRI), will be improved with the increase of the thickness, but when the thickness of the shielding layer 40 exceeds 27 mm, the shielding capability of the flat ribbon type conductive wire body only changes slightly without obvious improvement; when the thickness of the shielding layer 40 is between 0.001 mm and 27 mm, the increment of the bending radius of the flat ribbon type conductive wire body increases with the increase of the thickness, but when the thickness of the shielding layer 40 exceeds 27 mm, the increment of the bending radius of the flat ribbon type conductive wire body is more than 200 mm, which is not conducive to practical processing. Therefore, the thickness of the shielding layer is exemplarily 0.001 mm to 27 mm

On the basis of the above embodiments, the surface area of the insulating layer covered by the shielding layer may be set as needed. Table 5 shows the shielding effectiveness of the flat ribbon type conductive wire body when the shielding layer covers 0.8% to 7.8% of the surface area of the insulating layer. Table 6 shows the shielding effectiveness of the flat ribbon type conductive wire body when the shielding layer covers 0.8% to 100% of the surface area of the insulating layer.

TABLE 5

| | Covered area of insulating layer | | | | | | | |
|---|---|---|---|---|---|---|---|---|
| Parameter | 0.80% | 1.80% | 2.80% | 3.80% | 4.80% | 5.80% | 6.80% | 7.80% |
| Shielding effectiveness | 5.2 dB | 6.8 dB | 7.9 dB | 12.6 dB | 14.8 dB | 16.5 dB | 18.2 dB | 20.2 dB |

TABLE 6

| | Covered area of insulating layer | | | | | |
|---|---|---|---|---|---|---|
| Parameter | 0.80% | 7.80% | 17.80% | 27.80% | 37.80% | 47.80% |
| Shielding | 5.2 dB | 20.2 dB | 20.4 dB | 20.6 dB | 22.4 dB | 27.3 dB |
| effectiveness | | | | | | |
| | Covered area of insulating layer | | | | | |
| Parameter | 57.80% | 67.80% | 77.80% | 87.80% | 97.80% | 100% |
| Shielding | 29.6 dB | 31.4 dB | 33.3 dB | 35.9 dB | 38.6 dB | 40.2 dB |
| effectiveness | | | | | | |

As can be seen from the test results shown in Tables 5 and 6, when the surface area of the insulating layer covered by the shielding layer is less than 7.8%, the shielding effectiveness of the flat ribbon type conductive wire body is less than 20 dB, which does not meet the relevant use requirements, and when the surface area of the insulating layer covered by the shielding layer is greater than or equal to 7.8%, the shielding effectiveness is relatively good. Therefore, the shielding layer covers at least 7.8% of the surface area of the insulating layer.

Further, on the basis of any of the above technical solutions, the insulating layer 20 may be made of plastic, rubber, or the like. The insulating layer 20 may be formed by one or more selected from the group consisting of an extrusion process, an injection molding process, a spraying process, a dipping molding process, a slush molding process, an electrophoresis process, a winding process and a weaving process. The insulating layer 20 formed by the above processes has a sufficient strength, a good stability, and a high production efficiency.

The winding process means that a strip with insulating and adhesive material is wound on the conductive wire body for multiple layers to form a staggered compact structure, so that an insulating closed environment is formed due to the viscosity of the insulating and adhesive material.

The weaving process means that a strip with insulating and adhesive material is woven and wound on the outer side of the conductive wire body for multiple layers to form a staggered compact structure, so that an insulating closed environment is formed due to the viscosity of the insulating and adhesive material.

The extrusion process means a processing method in which under the action between a barrel and a screw of an extruding machine, a material is heated and plasticized while pushed forward by the screw, and then continuously passes through a head of the extruding machine and a mold with a corresponding shape, so as to be fabricated into various cross-sectional products or semi-finished products.

The injection molding process means that the molten raw material is pressurized, injected, cooled and separated by an injection molding machine, so as to be fabricated into finished products with a certain shape in a mold with a corresponding shape.

The spraying process is a molding process in which a material is directly sprayed on a surface of an object to be processed or in a cavity, and then solidified and molded.

The dipping molding process is a plastic coating process, which may be classified into two types, i.e., powder dipping and liquid dipping, according to the raw material of dipping. The powder dipping is often used to coat metal surfaces, which has the characteristics of the firm and hard bonding of the powder coating. The liquid dipping process mostly uses hot dipping liquid. A thermoplastic coated film has the characteristic of being softened after being heated and cured into a film after being cooled, which is mainly a process of physical melting and plasticization, and the processing and production are simple. The coating of the liquid dipping is thick and soft, and can serve as a protective product independently from the mold.

The slush molding is also called as coating-coagulation molding, and it is an important method for fabricating hollow soft products with paste plastics. The advantages of the slush molding are low equipment cost, high production speed and simple process control, but the accuracies of thickness and weight of products are poor.

The electrophoresis process is a technological method in which a water-soluble organic coating with electric charges is uniformly dissolved in a solution, a metal material or a workpiece to be processed is taken as an anode or a cathode, and current is applied so that the organic coating is adhered to the workpiece to be processed and then dried and solidified to obtain finished products.

The protective layer 10 may be made of an insulating material, such as plastic, rubber, etc. The protective layer 10 may have both functions of protection and insulation, thereby improving the stability of the flat ribbon type conductive wire body. The protective layer 10 may be formed by one or more selected from the group consisting of an extrusion process, an injection molding process, a spraying process, a dipping molding process, a slush molding process, an electrophoresis process, a winding process, and a weaving process. The protective layer 10 formed by the above processes has a sufficient strength, a good stability, and a high production efficiency.

The protective layer 10 may have various structural forms. For example, the protective layer 10 includes a plurality of protective layer segments arranged at intervals along a length direction of the conductive core body 30. Optionally, the protective layer 10 is integrally disposed outside the insulating layer 20 to facilitate processing.

It should be noted that the insulating layer 20 and/or the protective layer 10 may be formed by one or more selected from the group consisting of an extrusion process, an injection molding process, a spraying process, a dipping molding process, a slush molding process, an electrophoresis process, a winding process, and a weaving process. The insulating layer 20 or the protective layer 10 formed by the above processes has a sufficient strength, a good stability, and a high production efficiency.

There may be one or more conductive core bodies, which will be described in detail with the following examples.

### Embodiment 1

On the basis of any of the above embodiments, there is one conductive core body in the flat ribbon type conductive wire body according to this embodiment. Specifically, as illustrated in FIG. 1, the flat ribbon type conductive wire body according to this embodiment includes a conductive core body 30, an insulating layer 20, a shielding layer 40, and a protective layer 10. There is one conductive core body 30, and correspondingly there is one insulating layer 20. The insulating layer 20 wraps the conductive core body 30, the shielding layer 40 wraps the insulating layer 20, and the shielding layer 10 wraps the shielding layer 40. Each of the protective layer 10, the insulating layer 20 and the conductive core body 30 may be of flat shape.

By providing the shielding layer 40, it is possible to make the flat ribbon type conductive wire body according to this embodiment have a good electromagnetic shielding function, a strong anti-electromagnetic interference capability and a low requirement for mounting space, and can be widely used in occasions having a high requirement for signal transmission stability; meanwhile, it is possible to avoid the problems of large occupied space and high cost resulting from the use of large-area shielding wires with a shielding function, and satisfy the space requirement of the whole vehicle for the wire harness layout.

### Embodiment 2

On the basis of any of the above embodiments, there are at least two conductive core

bodies in the flat ribbon type conductive wire body according to this embodiment. Specifically, as illustrated in FIGS. 2 to 11, the flat ribbon type conductive wire body according to this embodiment includes a protective layer 10, an insulating layer 20, a shielding layer 40, and at least two conductive core bodies 30. Each of the protective layer 10, the insulating layer 20 and the conductive core body 30 is of flat shape. At least one conductive core body 30 is externally wrapped by the insulating layer 20, and at least one insulating layer 20 is wrapped by at least one shielding layer 40. The protective layer 10 is the outermost layer of the flat ribbon type conductive wire body.

In this embodiment, the flat ribbon type conductive wire body includes at least two conductive core bodies 30, i.e., one flat ribbon type conductive wire body is integrated with a plurality of conductive core bodies 30, so as to achieve independent electrical connection of a plurality of paths, and a plurality of paths can be arranged by fixing one flat ribbon type conductive wire body according to this embodiment. On the one hand, it is possible to avoid the problem of poor connection stability when a plurality of flat ribbon type wire harnesses independent from each other are connected to form a plurality of paths, thereby avoiding the risk of falling off after loading. On another hand, a plurality of conductive core bodies 30 are integrated into one conductive wire body, so that the structure is regular and compact and occupies less mounting space. On still another hand, the process of assembling a plurality of flat ribbon type wire harnesses is saved, so that the mounting is convenient, the mounting efficiency is high, and the intelligent manufacturing is facilitated. In addition, by providing the shielding layer 40 outside the insulating layer 20, it is possible to make the flat ribbon type conductive wire body have a good electromagnetic shielding function, a strong anti-electromagnetic interference capability and a low requirement for mounting space, and can be widely used in occasions having a high requirement for signal transmission stability; meanwhile, it is possible to avoid the problems of large occupied space and high cost resulting from the use of large-area shielding wires with a shielding function, and satisfy the space requirement of the whole vehicle for the wire harness layout. The flat ribbon type conductive wire body according to this embodiment not only realizes a multi-path arrangement, but also achieves an electromagnetic shielding function.

The number of the at least two conductive core bodies 30 may be two, three, four, five, etc., which may be set as needed.

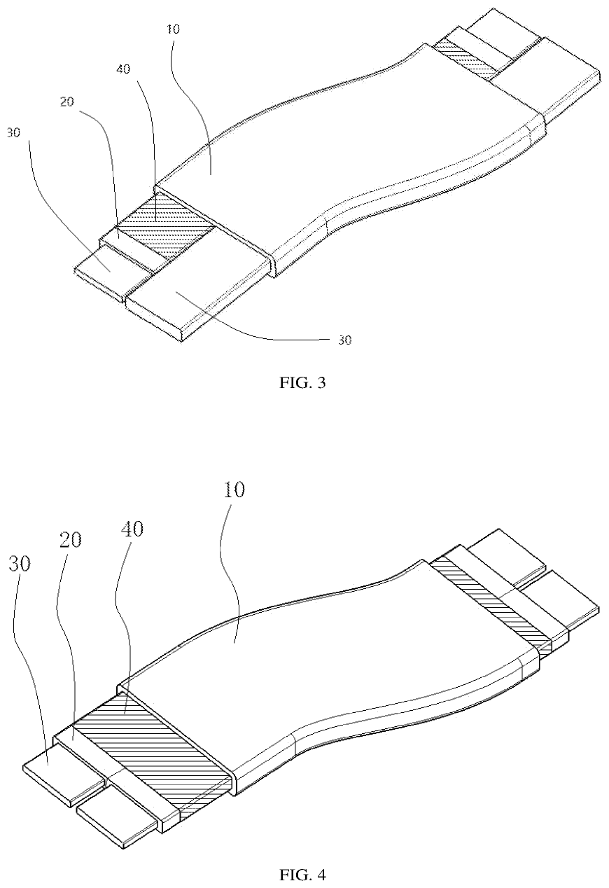

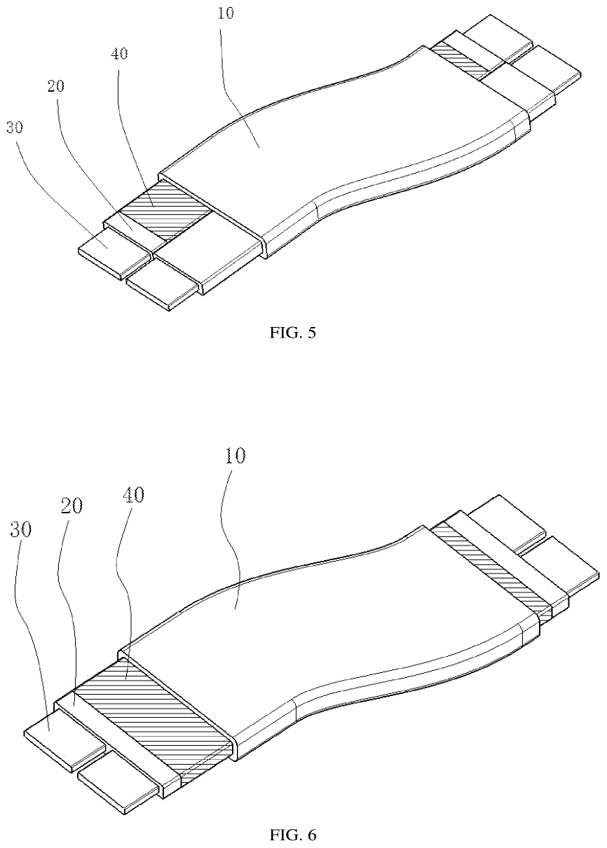

As illustrated in FIG. 3, only one or some of the plurality of conductive core bodies may be externally wrapped by the insulating layer 20, and other conductive core bodies 30 not wrapped by the insulating layer 20 are in direct contact with the protective layer 10, which may serve as the insulating layer thereof. Optionally, as illustrated in FIG. 5, each of the conductive core bodies 30 is externally wrapped by the insulating layer 20, which achieves a better insulating performance and facilitates processing. Optionally, as illustrated in FIGS. 4 to 11, each of the conductive core bodies 30 is externally wrapped by the insulating layer 20, which achieves a better insulating performance and facilitates processing.

The specifications of the plurality of conductive core bodies 30 may be different. Some conductive core bodies 30 may have a same specification and some conductive core bodies may have different specifications. Optionally, the plurality of conductive core bodies 30 have a same specification, i.e., the sizes of the plurality of conductive core bodies 30 are the same, and the structures of the plurality of conductive bodies 30 are the same, so as to facilitate processing.

The plurality of insulating layers 20 may be disposed in various ways. For example, the independent insulating layers 20 may be correspondingly formed by separately performing an extrusion process, an injection molding process, a spraying process, a dipping molding process, a slush molding process, an electrophoresis process, a winding process or a weaving process outside each of the conductive core bodies 30. Optionally, the integral insulating layer 20 may be formed by simultaneously performing an extrusion process, an injection molding process, a spraying process, a dipping molding process, a slush molding process, an electrophoresis process, a winding process or a weaving process outside the plurality of conductive core bodies 30, i.e., the plurality of insulating layers 20 are integrally formed. In this way, the flat ribbon type conductive wire body is more stable and the arrangement of the protective layer 10 is more convenient.

Further, on the basis of the above embodiments, the plurality of conductive core bodies 30 may be disposed in various ways. For example, the plurality of conductive core bodies are arranged in sequence along the width direction thereof, which may also be understood as that the plurality of conductive core bodies 30 are in a left-right arrangement

The positions of the plurality of conductive core bodies 30 may be different in the thickness direction thereof. For example, there are two conductive core bodies 30 disposed to be completely staggered; or, as illustrated in FIG. 2, one conductive core body 30 and the other conductive core body 30 are partially overlapped. Alternatively, some conductive core bodies 30 may have the same position and other conductive core bodies 30 may have different positions in the thickness direction thereof. For example, there are three conductive core bodies 30, two of which have the same position and the other of which has a position different from those of the above two conductive core bodies 30.

As an optional solution, as illustrated in FIGS. 3 and 4, the plurality of conductive core bodies 30 are disposed to be directly opposite to each other in the width direction thereof, i.e., the positions of the plurality of conductive core bodies 30 are consistent in the thickness direction thereof. It can also be understood that a side perpendicular to the width direction of the conductive core body is a first side, and the first sides of two adjacent conductive core bodies are disposed face to face, so that the flat ribbon type conductive wire body has a regular structure and is convenient to be processed and manufactured.

For another example, the plurality of conductive core bodies 30 may further be disposed in such a way that at least two conductive core bodies 30 are stacked along the thickness direction thereof, which may also be understood as that the plurality of conductive core bodies 30 are in an up-down arrangement.

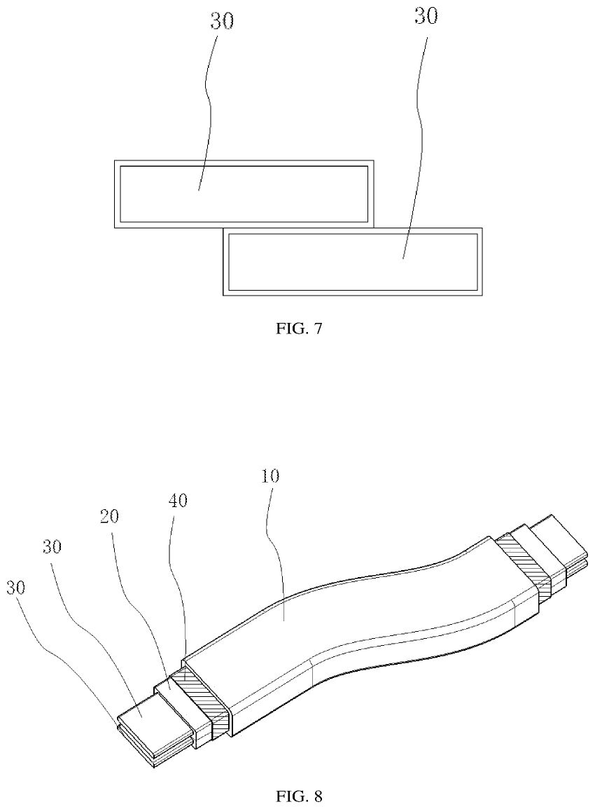

The positions of the plurality of conductive core bodies 30 may be different in the thickness direction thereof. For example, there are two conductive core bodies 30 disposed to be completely staggered; or, as illustrated in FIG. 7, one conductive core body 30 and the other conductive core body 30 are partially overlapped. Alternatively, some conductive core bodies 30 may have the same position and other conductive core bodies 30 may have different positions in the thickness direction thereof. For example, there are three conductive core bodies 30, two of which have the same position and the other of which has a position different from those of the above two conductive core bodies 30.

As an optional solution, as illustrated in FIGS. 8 to 10, the plurality of conductive core bodies 30 are disposed to be directly opposite to each other in the thickness direction thereof, i.e., the positions of the plurality of conductive core bodies 30 are consistent in the width direction thereof. It can also be understood that a side perpendicular to the thickness direction of the conductive core body is a second side, and the second sides of two adjacent conductive core bodies are disposed face to face, so that the flat ribbon type conductive wire body is of regular structure and convenient to be processed and manufactured.

For another example, the plurality of conductive core bodies 30 may further be disposed as follows: as illustrated in FIG. 11, a plurality of conductive core bodies 30 are disposed in both the width direction and the thickness direction thereof, i.e., the plurality of conductive core bodies 30 are stacked in both the thickness direction and the width direction thereof. The arrangement mode of the plurality of conductive core bodies 30 according to this embodiment is suitable for the case where there are at least three conductive core bodies 30.

As illustrated in FIGS. 5, 10 and 11, when a plurality of insulating layers 20 are disposed independently of each other, one shielding layer 40 wraps at least one insulating layer 20. For example, the number of the shielding layers 40 is the same as that of the insulating layers 20, both being plural, and the shielding layers 40 wrap the insulating layers 20 in one-to-one correspondence; or, the number of the shielding layers 40 is more than one, and is less than that of the insulating layers 20, and at least one shielding layer 40 wraps a plurality of insulating layers or, one shielding layer 40 simultaneously wraps a plurality of insulating layers 20. When a plurality of insulating layers 20 are integrally formed, the shielding layer 40 may directly wrap the outer walls of the plurality of insulating layers 20.

No matter whether a plurality of insulating layers 20 are disposed independently of each other or integrally formed, one insulating layer 20 is externally wrapped by at least one shielding layer 40, i.e., the number of the shielding layer(s) 40 may be one, two, three, four, etc. The insulating layer 20 layer may be externally wrapped by a plurality of shielding layers 40 seriatim from inside to outside.

It should be noted that the flat ribbon type conductive wire body according to the embodiments of the present disclosure may need to be bent in practical applications, and it can be bent in the same plane, which may be understood as that the bending portion of the flat ribbon type conductive wire body and the wire body portions of the flat ribbon type conductive wire body at both sides of the bending portion are located in the same plane. Alternatively, the wire body portion on one side of the bending portion is located in one plane, and the wire body portion on the other side of the bending portion is located in another plane. For example, the flat ribbon type conductive wire body is bent to form an acute angle, an obtuse angle, or a right angle, etc.

In practical applications, the flat ribbon type conductive wire body according to the embodiments of the present disclosure may be ungrounded, i.e., the shielding layer may be ungrounded. Alternatively, the shielding layer of the flat ribbon type conductive wire body according to the embodiments of the present disclosure may be at least partially grounded. Table 7 below shows the influences of the two cases on the anti-magnetic field interference capability, the anti-radio frequency interference capability, the electromagnetic interference capability and the safety capability.

TABLE 7

| | Technical capability | | | |
|---|---|---|---|---|
| | Anti-magnetic field | Anti-radio frequency | Electromagnetic | |
| State of shielding layer | interference capability | interference capability | interference capability | Safety capability |
| The shielding layer is | Having a risk of | Having a risk of radio | Having electromagnetic | The cable core is |
| ungrounded | electromagnetic | frequency interference | interferences to other | damaged, and the leaked |
| | interference | | components | current may burn the |
| | | | | insulating layer |
| The shielding layer is at | Obviously improving the | Obviously improving the | The added shielding | If the cable core is |
| least partially grounded | anti-electromagnetic | anti-radio frequency | layer can shield the | damaged, the leaked |
| | interference capability of | interference capability of | generated | current may flow into a |
| | the flat ribbon | the flat ribbon | electromagnetic field in | grounding grid along the |
| | | | the cable | shielding layer, which |
| | | | | achieves a safety |
| | | | | protection |

Further, on the basis of any of the above embodiments, the present disclosure further provides a flat ribbon type wire harness, which includes a terminal and the flat ribbon type conductive wire body according to any of the above technical solutions. The terminal is connected to an end of the flat ribbon type conductive wire body.

The flat ribbon type wire harness according to this embodiment has all the advantageous technical effects of the flat ribbon type conductive wire body, which will not be repeated here.

Finally, it should be noted that the above embodiments are only used to illustrate, rather than limiting, the technical solutions of the present disclosure. Although the present disclosure has been described in detail with reference to the aforementioned embodiments, those of ordinary skills in the art should appreciate that the technical solutions described in the aforementioned embodiments can still be modified, or some or all of the technical features can be replaced equivalently, without making the essence of the corresponding technical solutions deviate from the scope of the technical solutions of various embodiments of the present disclosure. In the specification provided herein, numerous specific details are set forth. However, it should be understood that the embodiments of the present disclosure can be practiced without these specific details. In some instances, well-known methods, structures and techniques have not been illustrated in detail so as not to obscure the understanding of the specification. Furthermore, those skilled in the art should appreciate that although some embodiments herein include features included in other embodiments, the combination of the features of different embodiments is meant to be within the scope of the present disclosure and form different embodiments.

1. A flat ribbon type conductive wire body, comprising: a conductive core body, an insulating layer, and a shielding layer, wherein the insulating layer wraps the conductive core body, and the shielding layer is disposed outside the insulating layer.

2. The flat ribbon type conductive wire body according to claim 1, further comprising a protective layer which wraps the shielding layer.

3. The flat ribbon type conductive wire body according to claim 1, wherein the shielding layer comprises a shielding tape which is wound to wrap an outer side of the insulating layer.

4. The flat ribbon type conductive wire body according to claim 3, wherein the shielding tape is spirally wound with a set overlapping width on the insulating layer.

5. The flat ribbon type conductive wire body according to claim 4, wherein the set overlapping width is 1% to 95% of a width of the shielding tape.

6. The flat ribbon type conductive wire body according to claim 5, wherein the set overlapping width is 5% to 50% of the width of the shielding tape.

7. The flat ribbon type conductive wire body according to claim 1, wherein the shielding layer is made of one or more selected from the group consisting of a shielding metal and a composite material thereof, a shielding plastic, a shielding rubber, and shielding fabrics.

8. The flat ribbon type conductive wire body according to claim 1, wherein a thickness of the shielding layer is 0.001 mm to 27 mm.

9. The flat ribbon type conductive wire body according to claim 1, wherein the shielding layer covers at least 7.8% of a surface area of the insulating layer.

10. The flat ribbon type conductive wire body according to claim 1, wherein a thickness of an interval between the insulating layer and the shielding layer is not greater than 157 mm.

11. The flat ribbon type conductive wire body according to claim 1, wherein the insulating layer wraps the conductive core body by means of one or more selected from the group consisting of an extrusion process, an injection molding process, a spraying process, a dipping molding process, a slush molding process, an electrophoresis process, a winding process, and a weaving process.

12. The flat ribbon type conductive wire body according to claim 2, wherein the protective layer wraps the shielding layer by means of one or more selected from the group consisting of an extrusion process, an injection molding process, a spraying process, a dipping molding process, a slush molding process, an electrophoresis process, a weaving process, and a winding process.

13. The flat ribbon type conductive wire body according to claim 1, wherein a material of the conductive core body is one or more selected from the group consisting of aluminum, aluminum alloy, copper, copper alloy, silver, and silver alloy.

14. The flat ribbon type conductive wire body according to claim 1, wherein a material of the conductive core body contains carbon or carbon-based compounds.

15. The flat ribbon type conductive wire body according to claim 1, wherein a material of the insulating layer is one or more selected from the group consisting of polyvinyl chloride, polyurethane, nylon, polypropylene, silicone rubber, crosslinked polyolefin, synthetic rubber, polyurethane elastomer, crosslinked polyethylene, and polyethylene.

16. The flat ribbon type conductive wire body according to claim 1, wherein the number of the conductive core body is one.

17. The flat ribbon type conductive wire body according to claim 1, wherein the number of the conductive core bodies is at least two, at least one of the conductive core bodies is externally wrapped by the insulating layer, and at least one insulating layer is wrapped by at least one shielding layer.

18. A flat ribbon type wire harness, comprising a terminal and the flat ribbon type conductive wire body according to claim 1, wherein the terminal is connected to an end of the conductive core body.
